(19) United States
(12) Patent Application Publication
(10) Pub. No.: US 2020/0102786 A1
(43) Pub. Date: Apr. 2, 2020

(54) BALCONY BUG NETTING SYSTEM

(71) Applicant: Paul Diec, Toronto (CA)

(72) Inventor: Paul Diec, Toronto (CA)

(21) Appl. No.: 16/164,270

(22) Filed: Oct. 18, 2018

(30) Foreign Application Priority Data
Oct. 2, 2018 (CA) 3,019,541

(51) Int. Cl. E06B 9/54

(52) U.S. Cl. CPC E06B 9/54; E06B 2009/543

(57) ABSTRACT

A balcony bug netting system including: a balcony bug netting assembly including at least one screen-member, each screen-member having (being defined by) a perimeter, a front-side, and a back-side; a screen-bar; a plurality of pivot posts; tracks; a plurality of feet; a plurality of support posts; a plurality of attachers; and a plurality of end-posts. The balcony bug netting system is anchorless and is configured, when assembled, to exclude pests from entering a volume of space effectively enclosed by the balcony bug netting assembly.

### BACKGROUND OF THE INVENTION

This application claims benefit under 35 USC 119 to Canada National Application No. 3,019,541 filed on Oct. 2, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of flexible or portable closure, partition, or panels of existing art and more specifically relates to a flexible panel removably mounted in slidable rigid closure guides.

### RELATED ART

Many individuals in modern society live in residential buildings and apartments. These individuals often work in commercial buildings. Residential buildings such as houses may have patios and balconies; apartments may also have patios and/or balconies. A balcony is a platform projecting from the wall of a building, conventionally supported by columns or console brackets, and enclosed with a balustrade, usually above the ground floor. Balconies are used by those dwelling in the building to gain access to fresh air and for views of the surrounding landscape. Many times these instances of use are interrupted by bugs and pests which make it uncomfortable to remain in the fresh outdoor environment. Further, pests and bugs may enter within the dwelling when the individual returns inside. This is not desirable. It is desirable to be able to enjoy the use of the balcony without interruption from pests. A suitable solution is needed.

U.S. Pat. No. 7,007,735 to Terrence S. Lake relates to a removable and adjustable screen. The described removable and adjustable screen includes a removable device having a screen, two stiles and two rails, connected by elbows. The rectangular screen admits light and air. The two stiles stand mutually parallel, rigid, and perpendicular to the horizon upon installation of the device in an opening. The two rails lie mutually parallel, rigid, and parallel to the horizon. The first elbows receive the rail coaxial with a first spring and the stile coaxial with a second spring while having gripping means. Slightly different, the second elbows have an adjusting means. The stiles and the rails connect to the elbows around the perimeter of the screen.

### SUMMARY OF THE INVENTION

In view of the foregoing disadvantages inherent in the known flexible or portable closure, partition, or panels art, the present disclosure provides a novel balcony bug netting system. The general purpose of the present disclosure, which will be described subsequently in greater detail, is to provide a balcony bug netting system that is efficient and effective in use.

A balcony bug netting system is disclosed herein comprising: a balcony bug netting assembly including at least one screen-member, each screen-member having (being defined by) a perimeter, a front-side, and a back-side; a screen-bar; a plurality of pivot posts; tracks; a plurality of feet; a plurality of support posts; a plurality of attachers; and a plurality of end-posts. The balcony bug netting system is anchorless and is configured, when assembled, to exclude pests from entering a volume of space effectively enclosed by the balcony bug netting assembly.

A preferred embodiment comprises: a balcony bug netting assembly including at least one screen-member, each screen-member (having a perimeter, a front-side, and a back-side), a screen-bar, a plurality of pivot posts, tracks, a plurality of feet, a plurality of support posts, a plurality of attachers, and a plurality of end-posts. In this embodiment the tracks are 6 inches in height and comprise weatherstrips. The tracks comprise threaded holes and slots; wherein the tracks are used to support the support posts and the pivot posts. The support posts are threadedly telescopic, and the pivot posts comprise a shield to slide down to cover the feet to make the pivot post seamless. The feet comprise a rubber pad with metal studs to ‘grab’ (but not damage) a planar floor surface such as a cement balcony floor. The end-posts each comprise a latch to couple to the screen-member and the screen-bar, and the end-posts each preferably comprise a bar-hinge to couple to the screen-member. The screen-bar is threadingly telescopic and comprises guide wheels, a spring-loaded hinge, hooks, and a u-handle. A crankshaft is configured to manipulate the balcony bug netting assembly, wherein the crankshaft comprises a wheel, a large-spindle, a small-spindle, a wheel, a shaft and a shaft holder. The balcony bug netting system in this embodiment is anchorless and is configured, when assembled, to exclude pests from entering a volume of space effectively enclosed by the balcony bug netting assembly. A kit is also described herein.

A method of use for the balcony bug netting system is also disclosed herein; the method comprising the steps of: one, providing a balcony bug netting system comprising: a balcony bug netting assembly including at least one screen-member, (each screen-member having a perimeter, a front-side, and a back-side), a screen-bar, a plurality of pivot posts, tracks, anchors, a plurality of feet, a plurality of support posts, a plurality of attachers, and a plurality of end-posts, and two assembling the balcony bug netting system to exclude pests (birds, insects and the like) from entering a volume of space effectively enclosed by the balcony bug netting assembly. The method may further comprise the step of: adjusting the balcony bug netting assembly as needed to fit contours of the balcony.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a balcony bug netting system, constructed and operative according to the teachings of the present disclosure.

FIG. 1 is a perspective view of the balcony bug netting system during an ‘in-use’ condition, according to an embodiment of the disclosure.

FIG. 2 is a perspective view of components of the balcony bug netting system of FIG. 1, according to an embodiment of the present disclosure.

FIG. 3 is a perspective view of components of the balcony bug netting system of FIG. 1, according to an embodiment of the present disclosure.

FIG. 4 is a perspective view of components of the balcony bug netting system of FIG. 1, according to an embodiment of the present disclosure.

FIG. 5 is a flow diagram illustrating a method of use of the balcony bug netting system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a flexible or portable closure, partition, or panel and more particularly to a balcony bug netting system as used to improve the ability of individuals to exclude pests from certain areas such as balconies.

Generally, the present invention is an anchorless and all-adjustable screening for balconies. The apparatus is also seamless to the smallest insects as in mosquitoes, with the accessories. It's adjustable to different shapes of balcony.

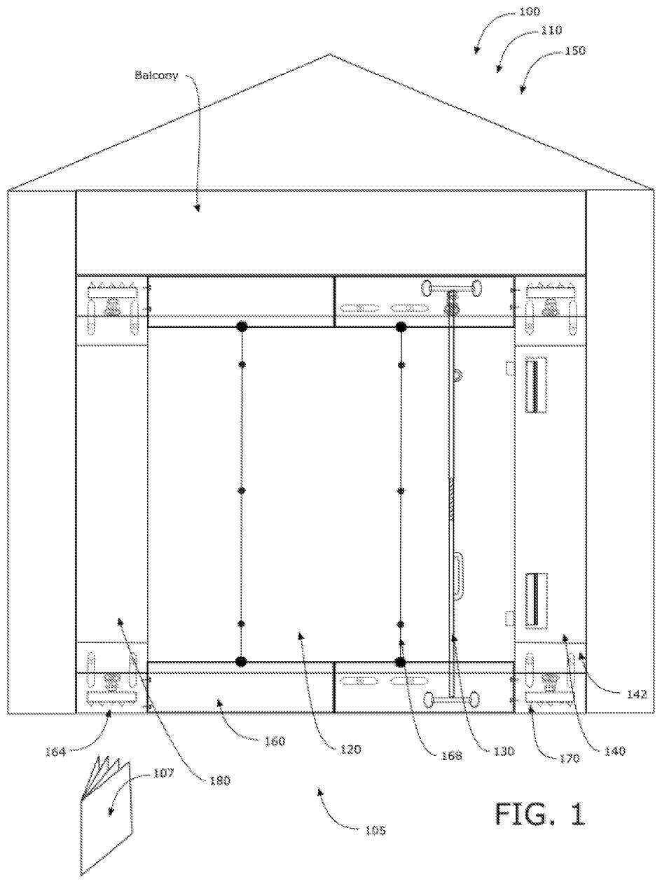

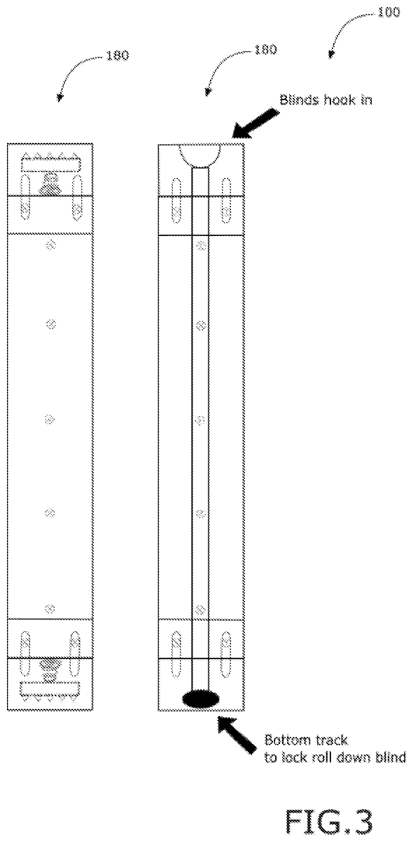

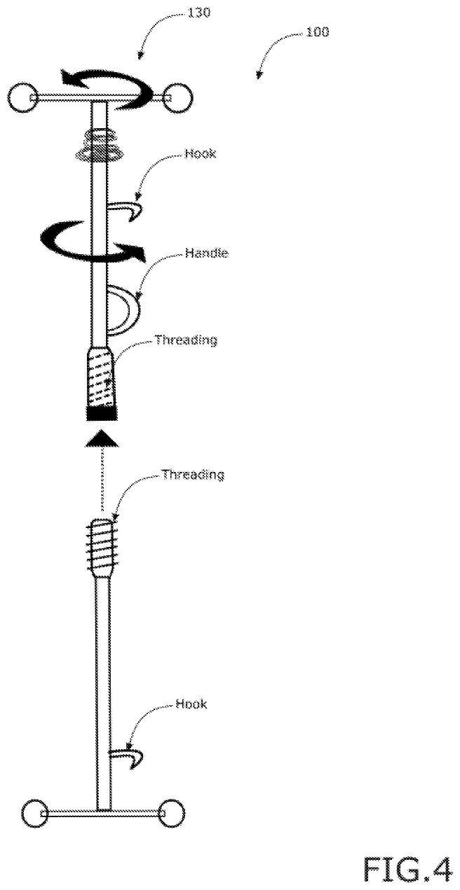

Referring now more specifically to the drawings by numerals of reference, there is shown in FIGS. 1-4, various views of the balcony bug netting system 100.

FIG. 1 shows the balcony bug netting system 100 during an ‘in-use’ condition 150, according to an embodiment of the present disclosure. Here, the balcony bug netting system 100 may be beneficial for use by a user to effectively prevent pests from entering into a desired pest-free area. As illustrated, the balcony bug netting system 100 may include a balcony bug netting assembly 110 including at least one screen-member 120, each screen-member 120 having (being defined by) a perimeter, a front-side, and a back-side; a screen-bar 130; a plurality of pivot posts 140; tracks 160; a plurality of feet 164; a plurality of support posts 168; a plurality of attachers 170; and a plurality of end-posts 180. The balcony bug netting system 100 is ‘anchorless’ and is configured, when assembled, to exclude pests from entering a volume of space effectively enclosed by the balcony bug netting assembly 110. As designed, the present invention may be used with balconies and not cause damage to the floor or to the host building. The device may be installed, used and removed at will. Embodiments may include vertically operable screen-members 120 and horizontally operable screen-members 120.

According to one embodiment, the balcony bug netting system 100 may be arranged as a kit 105. In particular, the balcony bug netting system 100 may further include a set of instructions 107. The instructions 107 may detail functional relationships in relation to the structure of the balcony bug netting system 100 such that the balcony bug netting system 100 can be used, maintained, or the like, in a preferred manner.

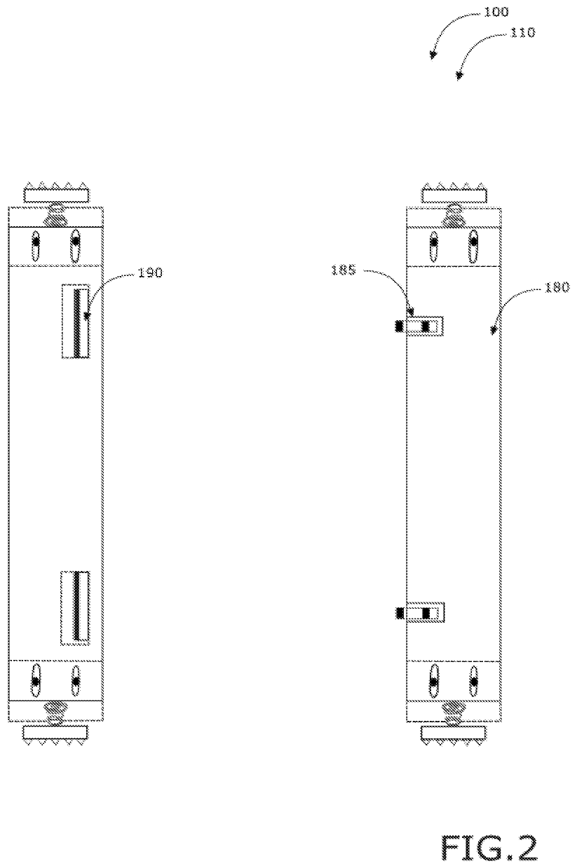

Referring now to FIGS. 2-4 show various views of the balcony bug netting system 100 of FIG. 1, according to an embodiment of the present disclosure. Further defining the above, balcony bug netting system 100, the volume of space comprises an envelope on a balcony (or patio or the like). The volume of space referred to may alternately comprise an envelope on a non-balcony. The pests referred to herein may comprise insects; wherein the insects are flying-insects (or non-flying). The pests may also comprise birds or the like. The balcony bug netting assembly 110 is adjustable via manual means in preferred embodiments but may comprise non-manual means in alternate embodiments.

Now referring to various components; the tracks 160 are 6 inches in height and preferably comprise weatherstrips. The tracks 160 comprise threaded holes and slots; wherein the tracks 160 are used to support the support posts 168 and the pivot posts 140. The support posts 168 are preferably threadedly telescopic. The pivot posts 140 each comprise a shield 142 to slide down to cover the feet 164 to make each pivot post 140 seamless. The feet 164 comprise a rubber pad with metal studs to ‘grab’ (but not damage) a planar floor surface such as a cement balcony floor. The end-posts 180 each comprise a latch 185 to couple to the screen-member 120 and the screen-bar 130. The end-posts 180 each preferably comprise a bar-hinge 190 to couple to the screen-member 120 and screen-member 120 may be locked in place in relation to end-posts 180. The screen-bar 130 is also preferably threadingly telescopic and comprises guide wheels, a spring-loaded hinge, hooks, and a u-handle. Those with ordinary skill in the art will now appreciate that upon reading this specification and by their understanding the art of screen bars as described herein, methods of attachment, adjustment, relative travel and manipulation will be understood by those knowledgeable in such art.

A crankshaft is configured to manipulate the balcony bug netting assembly 110; wherein the crankshaft comprises a wheel, a large-spindle, a small-spindle, a wheel, a shaft and a shaft holder. The tracks 160 may have double-sided tape installed thereon. The threaded holes on tracks 160 may be useful for installing bolts therethrough for mounting and to support the support posts 168 and the pivot posts 140. Slots may be included for adjustability when tightening the present invention together. The tracks 160 may comprise a magnetic strip in certain embodiments. The tracks 160 may also comprise hinges that may be welded to facilitate installation of the support posts 168 and/or the pivot posts 140. The tracks 160 may comprise weatherstripping,

As mentioned, the end-posts 180 each comprise a latch 185 to couple to the screen-member 120 and the screen-bar 130 for suitably manipulating the present invention. The end-posts 180 each comprise a bar-hinge 190 to couple to the screen-member 120. The screen-member 120 comprises mesh of suitable weave to provide privacy to occupants and keep pests outside of the enclosed envelope. The balcony bug netting assembly 110 is able to be opened and alternately closed. The balcony bug netting system 100 is ‘anchorless’ since the feet 164 comprise a rubber pad with metal studs to grab a planar floor surface including concrete yet not damage the floor surface. As such, the feet 164 are not permanently coupled to the planar floor surface.

The pivot posts 140 comprise a shield 142 to slide down to cover the feet 164 to make the pivot post 140 seamless; wherein the pivot post 140 preferably comprises a 45-50 degree angle for use on a triangular shaped balcony. Other angles may be used for different shaped balconies. The tracks 160 preferably comprise ferrous or non-ferrous material for suitable durability in supporting the support posts 168 and the pivot posts 140. The tracks 160 may comprise other suitable material that is suitably not degraded by the ambient conditions and the tracks 160 preferably comprise threaded holes and slots for adjustability of the balcony bug netting assembly 110 during use. Upon reading this specification, it should be appreciated that, under appropriate circumstances, considering such issues as user preferences, design preference, structural requirements, marketing preferences, cost, available materials, technological advances, etc., other fastening means and arrangements such as, for example, threading, clips, clasps, snaps, detents, alternate fastening means may be employed, etc., may be sufficient.

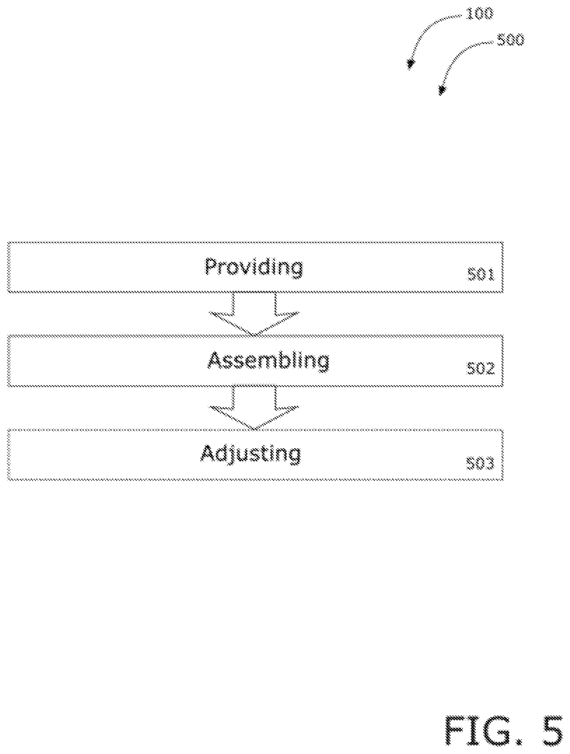

FIG. 5 is a flow diagram illustrating a method of use 500 of the balcony bug netting system 100, according to an embodiment of the present disclosure. In particular, the method of use 500 may include one or more components or features of the balcony bug netting system 100 as described above. As illustrated, the method of use 500 may include the steps of: step one 501, providing a balcony bug netting system as previously disclosed herein; step two 502, assembling the balcony bug netting system to exclude pests (birds, insects and the like) from entering a volume of space effectively enclosed by the balcony bug netting assembly; step three 503, adjusting the balcony bug netting assembly as needed to fit contours of the balcony.

It should be noted that step 503 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for installing, use, maintaining e.g., different step orders within above-mentioned list, elimination or addition of certain steps, including or excluding certain maintenance steps, etc., are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A balcony bug netting system comprising:
a balcony bug netting assembly including
at least one screen-member, each said screen-member having
a perimeter;
a front-side; and
a back-side;
a screen-bar;
a plurality of pivot posts;
tracks;
a plurality of feet;
a plurality of support posts;
a plurality of attachers; and
a plurality of end-posts; and
wherein said balcony bug netting system is anchorless and is configured, when assembled, to exclude pests from entering a volume of space effectively enclosed by said balcony bug netting assembly.

2. The balcony bug netting system of claim 1, wherein said volume of space comprises an envelope on a balcony.

3. The balcony bug netting system of claim 1, wherein said volume of space comprises an envelope on a non-balcony.

4. The balcony bug netting system of claim 1, wherein said pests comprises insects.

5. The balcony bug netting system of claim 4, wherein the insects are flying-insects.

6. The balcony bug netting system of claim 1, wherein the pests comprise birds.

7. The balcony bug netting system of claim 1, wherein the balcony bug netting assembly is adjustable via manual means.

8. The balcony bug netting system of claim 1, wherein the balcony bug netting assembly is seamless via a sliding shield.

9. The balcony bug netting system of claim 1, wherein the screen-member provides privacy to occupants via said at least one screen-member.

10. The balcony bug netting system of claim 1, wherein the balcony bug netting assembly is able to be opened and alternately closed.

11. The balcony bug netting system of claim 1, wherein said feet comprise a rubber pad with metal studs to grab a planar floor surface including concrete.

12. The balcony bug netting system of claim 1, wherein said pivot posts comprise a shield to slide down to cover said feet to make said pivot post seamless.

13. The balcony bug netting system of claim 1, wherein said tracks support said support posts and said pivot posts.

14. The balcony bug netting system of claim 1, wherein said tracks comprise threaded holes and slots for adjustability of said balcony bug netting assembly during use.

15. The balcony bug netting system of claim 1, wherein the pivot post comprises a 45-50 degree angle for use on a triangular said balcony.

16. The balcony bug netting system of claim 11, wherein the feet are not permanently coupled to said planar floor surface.

17. A balcony bug netting system comprising:
a balcony bug netting assembly including
at least one screen-member, each said screen-member having
a perimeter;
a front-side; and
a back-side;
a screen-bar;
a plurality of pivot posts;
tracks;
a plurality of feet;
a plurality of support posts;
a plurality of attachers; and
a plurality of end-posts;
wherein said tracks are 6 inches in height;
wherein said tracks comprise weatherstrips;
wherein said tracks comprise threaded holes and slots;
wherein said tracks support said support posts and said pivot posts;
wherein said support posts are threadedly telescopic;
wherein said pivot posts comprise a shield to slide down to cover said feet to make said pivot post seamless;
wherein said feet comprise a rubber pad with metal studs to grab a planar floor surface;
wherein said end-posts each comprise a latch to couple to said screen-member and said screen-bar;
wherein said end-posts each comprise a bar-hinge to couple to said screen-member;
wherein said screen-bar is threadingly telescopic and comprises guide wheels, a spring-loaded hinge, hooks, and a u-handle;
wherein a crankshaft is configured to manipulate said balcony bug netting assembly;
wherein said crankshaft comprises a wheel, a large-spindle, a small-spindle, a wheel, a shaft and a shaft holder;
wherein said balcony bug netting system is anchorless and is configured, when assembled, to exclude pests from entering a volume of space effectively enclosed by said balcony bug netting assembly.

18. The balcony bug netting system of claim 17, further comprising set of instructions; and
wherein the balcony bug netting system is arranged as a kit.

19. A method of use for the balcony bug netting system, the method comprising the steps of:
providing a balcony bug netting system comprising:
a balcony bug netting assembly including
at least one screen-member, each said screen-member having
a perimeter;
a front-side; and
a back-side;
a screen-bar;
a plurality of pivot posts;
tracks;
anchors;
a plurality of feet;
a plurality of support posts;
a plurality of attachers; and
a plurality of end-posts; and
assembling said balcony bug netting system to exclude pests from entering a volume of space effectively enclosed by said balcony bug netting assembly.

20. The method of claim 19, further comprising the step of adjusting said balcony bug netting assembly as needed to fit contours of said balcony.
